(19) United States
(12) Patent Application Publication
(10) Pub. No.: US 2005/0246246 A1
(43) Pub. Date: Nov. 3, 2005

(54) Inventory and sales analysis tool

(75) Inventors: Keiichi Nishimoto, Santa Clara, CA (US); Takashi Murata, Tokyo (JP); Takaji Tomibe, Tokyo (JP)

Correspondence Address: BRINKS HOFER GILSON & LIONE, P.O. BOX 10395, CHICAGO, IL, 60610, US

(73) Assignee: Alps Electric USA, Inc.

(21) Appl. No.: 10/834,655

(22) Filed: Apr. 28, 2004

(51) Int. Cl. G06F 17/60

(52) U.S. Cl. 705/28

(57) ABSTRACT

Feedback is provided to employees regarding inventory levels or sales revenue levels. The feedback may alert, for example, inventory managers to inventory characteristics that call for analysis, investigation, and responsive action. A company may thereby better manage its inventory, save money, and more efficiently produce its products.

### BACKGROUND

1. Technical Field

This invention relates to a data processing system for communicating information regarding inventory or sales levels. More specifically, the invention relates to determining inventory or sales level compliance and responsively alerting an inventory manager, for example, through a visual modification to a graphical inventory representation.

2. Background Information

Rapid advances in technology have brought the large scale production of an enormous spectrum of consumer products. Each product, of course, commonly includes dozens, if not hundreds or thousands of individual components. Therefore, in a modern manufacturing setting, sales companies must maintain extensive inventories of components that may be shipped to producers that build those consumer products.

As a result, in many cases a sales company needs to track great volumes of components, maintain adequate inventories of the components to meet product demand, and account for timing relationships between component ordering, shipment, receipt, and stocking. The related volume of data is often extremely difficult to sort through, track, and manage. Consequently, a sales company may not be able to easily maintain adequate component inventories. The sales company therefore faces serious risks of running low on components and not meeting product demand, or over ordering components, thereby overspending and unduly enlarging their inventories. The economic impact on the sales company can be severe.

A need has long existed for addressing the problems noted above and other previously experienced.

### BRIEF SUMMARY

Methods and systems consistent with the present invention provide feedback regarding inventory levels or sales levels. For example, the methods and systems may alert the inventory managers to inventory characteristics calling for additional analysis and investigation. For that reason, a sales company may better manage its inventory, save money, and more efficiently produce its products.

Methods consistent with the present invention provide inventory level monitoring and feedback. The method includes determining an actual inventory level for an inventory item, determining a target inventory level for the inventory item, and displaying a graphical representation for the actual inventory level and the target inventory level. The method may then compare the target inventory level against the actual inventory level to determine inventory compliance, and responsively modify a display characteristic of the graphical representation based on the inventory compliance.

Systems consistent with the present invention include a memory that stores an inventory analysis program, and a processor for executing the inventory analysis program. The inventory analysis program obtains an actual inventory level for an inventory item and a target inventory level for the inventory item and displays a graphical representation for the actual inventory level and the target inventory level. The inventory analysis program further determines inventory compliance based on the target inventory level and visually signals inventory non-compliance.

### BRIEF DESCRIPTION OF THE DRAWINGS

FIG. 1 illustrates a data processing system including an inventory analysis program that determines inventory compliance or non-compliance so that the data processing system may visually signal the compliance on a display.

FIG. 2 illustrates the data processing system of FIG. 1, in which inventory non-compliance has been signaled on the display.

FIG. 3 shows an example of the inventory days table that may be stored in the memory of the data processing system shown in FIG. 1 as an aid in determining inventory compliance.

FIG. 4 shows a selection menu for displaying graphical inventory representations on the display of the data processing system shown in FIG. 1.

FIG. 5 depicts a flow diagram of the steps taken by the inventory analysis program in the data processing system of FIG. 1.

### DETAILED DESCRIPTION

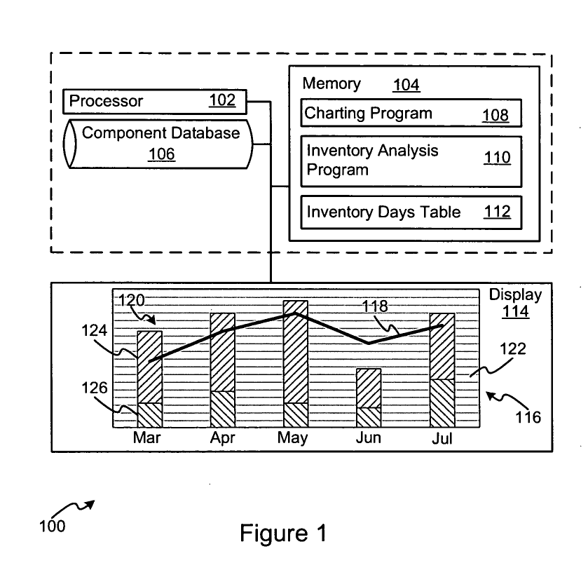

With regard first to FIG. 1, a data processing system 100 includes a processor 102, a memory 104, and a component database 106. The memory includes a charting program 108, an inventory analysis program 110, and an inventory days table 112. The data processing system also includes a display 114 that presents charts, graphs, and other graphical representations 116 of inventory or sales data to an individual, for example, a company manager.

As shown in FIG. 1, the inventory representation 116 is a bar chart showing a target inventory indicator 118, monthly actual inventory bars 120, and a display characteristic 122. The inventory bars 120 include an on-hand inventory section 124 and an in-transit inventory section 126. Other graphical representations may be used, however, including pie charts, scoreboards, and the like.

Although FIG. 1 shows a monthly representation of inventory levels, the representation 116 may show inventory at any other time scale. As examples, the inventory representation 116 may portray a daily, weekly, or yearly inventory representation. Further, the representation 116, regardless of the time frame illustrated, may be updated at any desired frequency. For example, the representation 116 may be a monthly representation of inventory that is updated daily according to sales predictions, inventory checks, and other factors.

The charting program 108 generates the inventory representation 116 on the display 114. In one implementation, the charting program 108 may be the Pop Chart server based suite of tools available from CORDA Technologies of Lindon Utah, USA. The charting program 108 thereby visualizes complex inventory data on the display 114 in many possible forms. As will be described in more detail below, the inventory analysis program 110 may provide parameters to the charting program 108 that specify, for example, the display characteristic 122 or other visualization parameter for creating the representation 116.

The analysis program 110 may proceed as noted below on any time scale. For example, the analysis program 110 may perform the determinations below on a daily, weekly, or monthly basis. In many instances, the analysis program proceeds on a daily basis. Accordingly, the analysis program 110 provides inventory or sales revenue feedback that is updated each day.

As noted above, the actual inventory bars 120 include an on-hand inventory section 124, and an in-transit inventory section 126. The on-hand inventory section 124 represents the amount or quantity of components that are currently present in inventory. The in-transit inventory section 126 represents the amount or quantity of components that have shipped, but have not yet arrived. Thus, in one implementation, the actual inventory level represents a sum of the amount or quantity of components on-hand and the amount or quantity being transported.

The component database 106 acts as a central repository for data concerning product groups or individual components in inventory. The component database 106 may include, for example, data fields for each product group that indicate how many of that product group component are on-hand, how many are in-transit, and the projected number of product group components needed on a daily, monthly, or other time basis. The component database 106 may further specify a product group identifier for each component, for example “CN” to indicate a product group for connector components. The components need not be indivisible parts. Instead, a component may be an assembly of multiple lower level components that, in turn, are assembled to form a complete product.

The inventory analysis program 110 analyzes the product group component data in relation to inventory projections. Depending on the result of the analysis, the analysis program 110 provides feedback regarding inventory levels. The feedback may take the form of a modification to the display characteristic 122 that alerts an inventory manager to inventory characteristics that may call for analysis, investigation, and responsive action. As examples, when the display characteristic is a background color, the feedback may be a change in the background color (e.g., from blue to red). As other examples, the display characteristic 122 may be a graphical shape, size, font, line thickness, line pattern, fill color, fill pattern, or other attribute associated with the inventory representation 116. The feedback may then be a modification to any of those characteristics.

As an example, a sales company may decide that actual inventory should remain below the target inventory to avoid over-stocking components. In that case, the analysis program 110 may set the display characteristic 122 to a blue background, for example, when the target inventory 118 exceeds the actual inventory 120 in an absolute sense, or by a pre-selected threshold (e.g., by 5%, 10%, 15%, 1-10%, 10-15%, or another threshold). The analysis program 110 may then modify the display characteristic 122 by changing the background color from blue to red, for example, when the actual inventory 120 exceeds the target inventory 118 in an absolute sense, or by a pre-selected threshold (e.g., by 5%, 10%, or 15%, 1-10%, 10-15%, or another threshold).

The inventory analysis program 110 determines a target inventory for a given product group (or, in other implementations, for individual components). The determination is not limited to any particular form or structure, and the discussion below is exemplary in nature only.

In one implementation, the analysis program 110 determines a target inventory level for any given product group for any given month according to:
T=(F*(1−V)/M)*A (Equation 1).

In Equation 1, T is the target inventory level for a given product group for the month, F is a backlog forecast or demand for the product group, M is a monthly time extent expressed in working days, V is a margin ratio for the component, and A is an inventory delay expressed in inventory days. Any of the parameters explained above may be updated on a continuous, daily, weekly, monthly, or other time basis.

The F parameter is typically expressed in terms of the amount of backlog. For example, the F parameter may represent the quantity of open orders scheduled to be delivered within a selected time period. In one implementation, the time period may be 22 days, but more or fewer days may also be employed, and the time period employed may be modified at any time. Thus, for example, open orders for the next 22 days for the CN product group may total 65,000 units. The component database 106 may store the backlog forecast for each product group, and it may be updated on a periodic basis (e.g., hourly, daily, or monthly).

The M parameter represents the duration of a particular month, or a duration applicable for multiple months. The duration may be expressed in terms of working days, total days per month, or another duration. For example, the parameter M may be set to 22 working days for each month analyzed.

The V parameter is the vendor margin ratio for the product group. In other words, V may be used to convert sales price to purchase price to increase the accuracy of the target inventory. For example, the components in the CN product group may have a margin ratio of 15% or 0.15. The margin ratio for the components may be set by the sales company, and stored in the component database 106 or in the inventory days table 112.

The A parameter represents an inventory delay associated with the component. For example, the A parameter may be determined as the sum of an in-transit days and an on-hand days. The in-transit days may correspond to the number of days that it takes for a component, once it departs from a supplier factory or other shipping location, to arrive at the sales company warehouse, or other location specified by the parties. The on-hand days may represent the number of days needed to meet customer demand, as examples, in a Vendor Managed Warehouse (VMI), or Just In Time (JIT) operation. As an example, the CN product group may have an in-transit days of 11 days, and an on-hand days of 3 days, resulting in a total inventory days of 14 days.

As one example of the application of Equation 1 to the CN product group, assume that the June demand forecast for the CN product group is 65,000 units. Then, T=(65,000*(1−0.15)/22)*14=35,159 units as the target inventory for June. The target inventory may be updated on a daily, weekly, monthly, or any other time basis.

The target inventory level may be determined in other manners, however. In another implementation, the analysis program 110 determines the target inventory according to:
T=(F/M)*A (Equation 2).

where T is the target inventory level, F is the backlog or open order forecast as explained above, M is the monthly time extent, and A is the inventory delay. Equation 2 eliminates consideration of the vendor margin ratio V from the determination of the target inventory level.

The inventory days table 112 may be stored in the memory 104. Alternatively, the inventory days table 112 may be part of the component database 106, or another database in the data processing system 100. The inventory days table 112 may include additional or fewer fields in other implementations. For example, the inventory days table 112 may omit the total days field 310 or the gross margin field 312 depending on the particular implementation desired.

The inventory analysis program 110 may access the inventory days table 112 during operation. Thus, for example, the inventory analysis program 110 may retrieve selected data from the inventory days table 112 for application to Equation 1 or Equation 2. Similarly, the inventory analysis program 110 may retrieve selected data such as monthly forecasts and monthly time extents from the component database 106 for application to Equation 1 or Equation 2.

Once the inventory analysis program 110 has determined the target inventory level, it may compare the target inventory level against the actual inventory level to determine inventory compliance. In response, the inventory analysis program 110 may modify the display characteristic 122 based on the inventory compliance. For example, the inventory analysis program 110 may direct the charting program 108 to change a background color, graphical shape, line pattern, or another display characteristic of the inventory representation 116.

As an example, the June target inventory level for the CN component may be 35,159 units. If, for example, the on-hand inventory for the CN component is 30,000 and the in-transit inventory for the CN component is 10,000 units, then the actual inventory level is 30,000+10,000=40,000 units. Because the actual inventory level exceeds the target inventory level, the inventory analysis program 110 changes, for example, the background color of the inventory representation 116 to red to alert the product manufacturer that too much inventory exists.

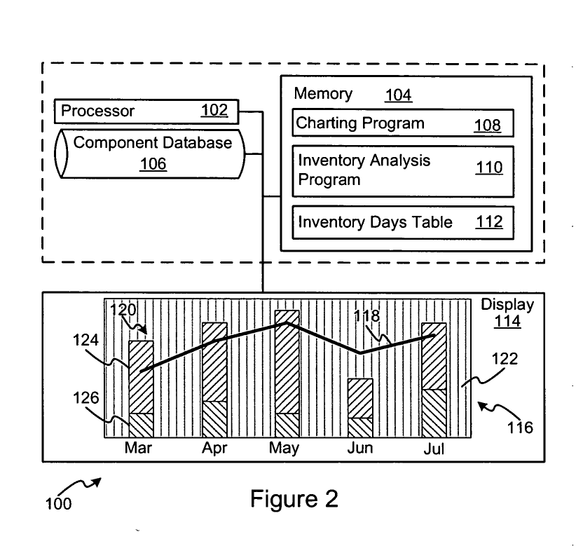

With regard to FIG. 2, that figure shows that the data processing system 100 has changed the display characteristic 122 in response to the inventory analysis. More specifically, the data processing system 100 has changed the inventory representation background from horizontal striping to vertical striping. As noted above, however, other modifications to the representation 116 may include changes in color, graphical shape, line weight, and other modifications. As a result, an inventory manager is alerted to the shortfall, may then examine the component inventory, plan to address the shortfall, and take action to address the shortfall.

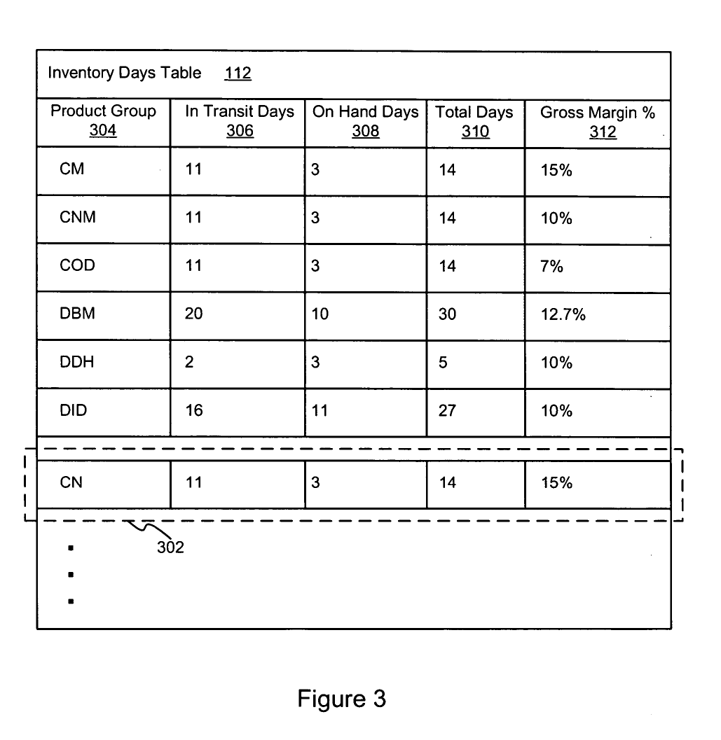

Turning next to FIG. 3, that figure shows one example of the inventory days table 112. The inventory days table 112 includes one or more product group records 302. Each component record includes a product group ID field 304, an in-transit days field 306, and an on-hand days field 308. In addition, the component record 302 includes a total days field 310, and a gross margin field 312.

In this example, the component record 302 specifies the string “CN” in the product group ID field to indicate the ‘connector’ product group. The component record 302 also stores a value of ‘11’ in the in-transit days field 306 to indicate that it takes approximately 11 days for the connector component to arrive at a specified sales company location after being shipped from a supplier factory or other site. Similarly, the on-hand days field 308 stores the value ‘3’ for the connector component to indicate 3 days of on-hand delay. The total days field 310 stores the sum of the in-transit days field 306 and the on-hand days field 308. Finally, the gross margin field 312 stores a value representative of the vendor margin for the connector component.

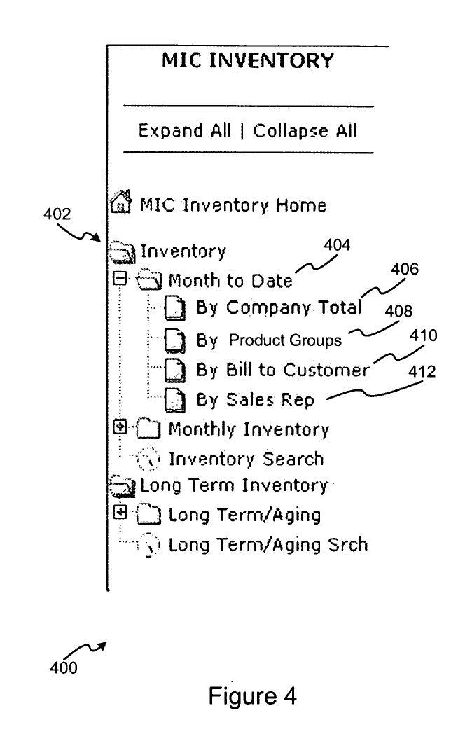

With regard next to FIG. 4, that figure shows a selection menu 400 for directing display of graphical inventory or sales revenue representations on the display 114. The selection menu 400 includes an inventory folder 402 with a month-to-date subfolder 404. The month-to-date subfolder 404 contains display representation selections 406, 408, 410, and 412 for total inventory, individual component inventory, customer inventory, and sales representative inventory, respectively. The analysis program 110 may respond to a hyperlink activation for any of the representation selections 406-412 by updating the inventory representation 116 as explained below.

The display representation selection 406 provides a hyperlink that may be activated to instruct the charting program 108 and inventory analysis program 110 to present a graphical view of inventory compliance at the company level. In other words, rather than displaying an inventory representation 116 for an individual selected product group, the charting program 108 may instead display an inventory representation for multiple product groups (e.g., all the product groups supplied by the supplier). In that case, the actual inventory bars 120 present a sum of the on-hand inventory and an in-transit inventory across all product groups.

Similarly, the display representation selection 408 provides a hyperlink that may be activated to display an inventory representation 116 at a selected product group level. For example, the product group level may be individual components, groups of related components (e.g., the CN product group), or another level of abstraction on the inventory maintained by the sales company.

The display representation selection 410 provides a hyperlink that may be activated to display an inventory representation 116 by customer billed for one or more components. For example, the actual inventory bars 120 may then present a sum of the on-hand inventory and an in-transit inventory for one or more product groups sold to a particular customer.

Similarly, the display representation selection 412 provides a hyperlink that may be activated to display an inventory representation 116 by the sales representative that sold components in one or more product groups. The actual inventory bars 120 may then present a sum of the on-hand inventory and an in-transit inventory across the product groups categorized by sales representative.

The inventory analysis program 110 may be extended to analyze other aspects of a company's performance as described above for inventory. For example, the inventory analysis program may additionally or alternatively compare predicted and actual sales data or predicted and actual sales revenue to determine discrepancies that warrant review. In that regard, the predicted and actual sales data may be expressed in terms of a particular component, multiple components, one or more sales representatives, in terms of sales for the company as a whole, or any other categorization.

Thus, for example, the data processing system 100 may determine that the actual monthly sales revenue of the CN product group fall below a target sales revenue level. In response, the data processing system 100 may change a graphical characteristic on the display 114. In response, a sales manger, for example, may take corrective action.

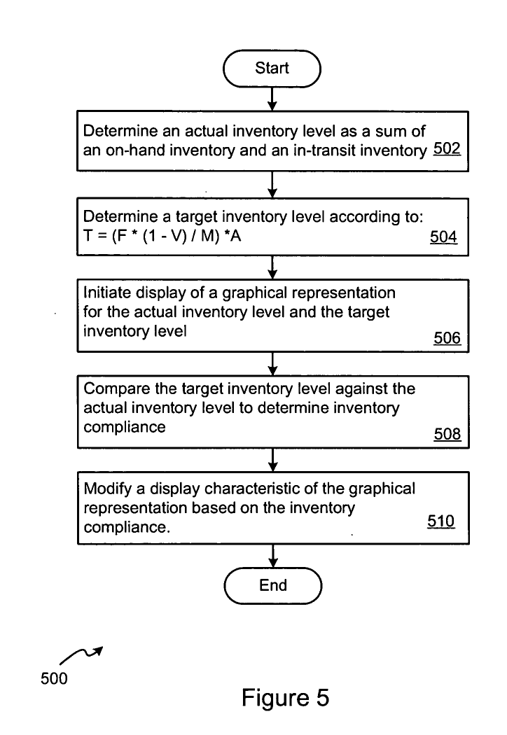

Turning to FIG. 5, that figure summarizes a flow diagram 500 of the steps that may be taken by the inventory analysis program 110 in the data processing system 100. The analysis program 110 determines an actual inventory level (Act 502). The actual inventory level may be, for example, the sum of an on-hand inventory level and an in-transit inventory level (Act 504). The analysis program 110 also determines a target inventory level according to Equation 1 or Equation 2, as examples.

The analysis program 110 initiates display of a graphical representation for the actual inventory level and the target inventory level (Act 506). For example, the analysis program (or another program in the data processing system 100) may call display functions in the charting program 108.

Once the analysis program 110 has determined the target inventory level and the actual inventory level, the analysis program 110 may then compare the actual inventory level and the target inventory level to determine inventory compliance (Act 508). Based on the inventory compliance, for example, when actual inventory exceeds the target inventory, the analysis program may then initiate modification of a display characteristic to alert a company employee who may take corrective action.

The methods and systems described above thereby provide feedback to managers regarding inventory levels or sales levels. The feedback may take the form of display characteristic modifications that alert the inventory manager to inventory characteristics that may call for analysis, investigation, and responsive action. The inventory manager may then take that responsive action and thereby better manage its inventory, save money, and more efficiently produce its products.

It is therefore intended that the foregoing detailed description be regarded as illustrative rather than limiting. For example, rather than analyzing inventory by product group, the processing system 100 may instead analyze by individual component. The following claims, including all equivalents, are intended to define the spirit and scope of this invention.

1. A method for inventory level monitoring and feedback, the method comprising:
determining an actual inventory level for an inventory item;
determining a target inventory level for the inventory item;
initiating display of a graphical representation for the actual inventory level and the target inventory level;
comparing the target inventory level against the actual inventory level to determine inventory compliance; and
modifying a display characteristic of the graphical representation based on the inventory compliance.

2. The method of claim 1, where the act of determining a target inventory level comprises the act of determining:
T=(F/M)*A,
where T is the target inventory level, F is a backlog forecast, M is a monthly time extent expressed in working days, and A is inventory days.

3. The method of claim 1, where the act of determining a target inventory level comprises the act of obtaining a margin ratio.

4. The method of claim 1, where the act of determining a target inventory level comprises the act of determining:
T=(F*(1−V)/M)*A,
where T is the target inventory level, F is a backlog forecast, M is a monthly time extent expressed in working days, V is a margin ratio, and A is inventory days.

5. The method of claim 1, where the act of modifying comprises changing a background color of the graphical representation.

6. The method of claim 1, where the act of modifying comprises changing at least one of a graphical shape, color, or size of an attribute of the graphical representation.

7. The method of claim 1, where the act of determining an actual inventory level comprises the act of determining an in-transit inventory level and an on-hand inventory level.

8. The method of claim 1, where the act of determining a target inventory level comprises the act of individually determining a target inventory level for multiple product groups.

9. The method of claim 1, where the act of determining a target inventory level comprises the act of individually determining a target inventory level for multiple product groups at a plurality of days in a month.

10. An inventory management data processing system comprising:
a memory comprising an inventory analysis program that obtains an actual inventory level for a product group and a target inventory level for the product group, displays a graphical representation for the actual inventory level and the target inventory level, determines inventory compliance based on the target inventory level, and visually signals inventory non-compliance; and
a processor for executing the inventory analysis program.

12. The data processing system of claim 11, where the memory further comprises an inventory table comprising a product group identifier field and an inventory days field.

13. The data processing system of claim 12, where the inventory table further comprises a margin ratio field.

14. The data processing system of claim 12, where the inventory days field comprises an in-transit days field and an on-hand days field.

15. The data processing system of claim 14, where the inventory analysis program retrieves an in-transit days entry and an on-hand delay entry for a pre-selected product group item and adds them to obtain a total inventory days, and determines the target inventory level according to:
T=(F/M)*A,
where T is the target inventory level, F is a backlog forecast, M is a monthly time extent expressed in working days, and A is inventory days.

16. The data processing system of claim 13, where the inventory analysis program retrieves a margin ratio entry for a pre-selected product group, and determines the target inventory level according to:
T=(F*(1−V)/M)*A,
where T is the target inventory level, F is a backlog forecast, M is a monthly time extent expressed in working days, V is the margin ratio, and A is inventory days.

17. The data processing system of claim 10, where the act of visually signaling comprises changing a background color of the graphical representation.

18. The data processing system of claim 10, where the act of modifying comprises changing at least one of a graphical shape, color, or size of an attribute of the graphical representation.

19. The data processing system of claim 10, where the target inventory level is determined for multiple product groups.

20. The data processing system of claim 10, where the target inventory level is individually determined for a plurality of product groups at a plurality of days in a month.

21. A machine-readable medium encoded with instructions that cause a data processing system to perform a method for inventory monitoring and feedback comprising the acts of:
obtaining an actual inventory level for a product group;
obtaining a target inventory level for the product group;
displaying a graphical representation for the actual inventory level and the target inventory level;
determining inventory compliance based on the target inventory level; and
signaling inventory non-compliance.

22. The machine readable medium of claim 21, where the method further comprises the acts of:
retrieving, from an inventory table, an in-transit days entry and an on-hand days entry for a pre-selected inventory item;
deriving an inventory days from the on-hand days and the in-transit days; and
determining the target inventory level according to:
T=(F/M)*A,
where T is the target inventory level, F is a backlog forecast, M is a monthly time extent, and A is inventory days.

23. The machine readable medium of claim 21, where the method further comprises the acts of:
retrieving, from an inventory table, a margin ratio entry for a pre-selected product group; and
determining the target inventory level according to:
T=(F*(1−V)/M)* A,
where T is the target inventory level, F is a backlog forecast, M is a monthly time extent, V is the margin ratio, and A is inventory days.

24. The machine readable medium of claim 21, where signaling inventory non-compliance comprises the act of changing a background color of the graphical representation.

25. The machine readable medium of claim 11, where signaling inventory non-compliance comprises the act of changing at least one of a graphical shape, color, or size of an attribute of the graphical representation.
